(19) United States
(12) Patent Application Publication
(10) Pub. No.: US 2006/0098741 A1
(43) Pub. Date: May 11, 2006

(54) Reproducing apparatus

(75) Inventors: Yasushi Unoki, Ome'shi (JP); Satoshi Akimoto, Machida-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/268,172

(22) Filed: Nov. 7, 2005

(30) Foreign Application Priority Data
Nov. 9, 2004 (JP) 2004-325753

(51) Int. Cl. H04N 11/02; H04N 11/04; H04N 7/12; H04B 1/66

(52) U.S. Cl. 375/240.25; 375/240.01

(57) ABSTRACT

A communications unit carries out communications with server via network. A buffer memory temporarily stores the data which the communications unit downloads from the server via the network. A decoding unit decodes the data read from the buffer memory. A control unit individually sets reproduction start threshold thₛ used to determine start of decoding the received data after start of the communications and BUF threshold thᵤ used to determine interruption of decoding after start of decoding the data, to control operations of the decoding unit.

### CROSS-REFERENCE TO RELATED APPLICATIONS

This application is based upon and claims the benefit of priority from prior Japanese Patent Application No. 2004-325753, filed Nov. 9, 2004, the entire contents of which are incorporated herein by reference.

### BACKGROUND OF THE INVENTION

1. Field of the Invention

This invention relates to a reproducing apparatus capable of reproducing data, for example, speech, images, etc.

2. Description of the Related Art

In a conventional reproducing apparatus, data read from an internal storage or data received from external equipment has been temporarily stored in a buffer memory so as to absorb fluctuation in reading or receiving data caused in reproducing(see, for example, Jpn. Pat. Appln. KOKAI Publication No. 2000-123477).

To absorb such fluctuation, the buffer memory needs to be controlled to prevent the data stored in the buffer memory from being exhausted. In addition, to start data reproduction, a sufficient amount of contents data needs to be stored in the buffer memory.

For this reason, in the conventional apparatus, the amount of data stored in the buffer memory has been detected before or during data reproduction, and data reproduction has been started or temporarily stopped by comparing the detected amount of data with a threshold.

However, if the threshold is high, much time is required until the data is stored in the buffer memory, and much time is thereby spent until the start of the data reproduction. On the other hand, if the threshold is small, it is likely to cause the exhaustion of the data stored in the buffer memory during the data reproduction, which causes buffer-underflow and thereby exerts an influence to the data reproduction.

### BRIEF SUMMARY OF THE INVENTION

The object of the present invention is to provide a reproducing apparatus capable of reducing the time required until the start of the data reproduction.

Another object of the present invention is to provide a reproducing apparatus capable of restricting occurrence of buffer-underflow and thereby reducing influences to the data reproduction.

According to an aspect of the present invention, there is provided an reproducing apparatus comprising input means for inputting encoded data, storage means for temporarily storing the data input by the input means, decoding means for decoding the data read from the storage means, and control means for reading the data stored by the storage means and outputting the data to the decoding means if the data is input by the input means and an amount of the data stored by the storage means becomes equal to or greater than a first threshold, and for stopping reading the data stored by the storage means if the amount of the data stored by the storage means becomes smaller than a second threshold that is smaller than the first threshold.

According to another aspect of the present invention, there is provided a reproducing apparatus comprising input means for inputting encoded data, storage means for temporarily storing the data input by the input means, decoding means for decoding the data read from the storage means, and control means for reading the data stored by the storage means and outputting the data to the decoding means if the data is input by the input means and an amount of the data stored by the storage means becomes equal to or greater than a first threshold, and for stopping reading the data stored by the storage means if the amount of the data stored by the storage means becomes smaller than a second threshold that is greater than the first threshold.

As described above, the first threshold used to determine the timing of decoding the data input by the input means and the second threshold used to prevent buffer-underflow after data decoding, are set separately in the present invention.

Therefore, the present invention can provide a reproducing apparatus with great user convenience, capable of restricting occurrence of buffer-underflow and thereby reducing influences to the data reproduction, by setting the second threshold to be smaller than the first threshold.

The present invention can also provide a reproducing apparatus with great user convenience, capable of reducing the time required until the start of the data reproduction, by setting the second threshold to be greater than the first threshold.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a structure of a reproducing apparatus according to a first embodiment of the present invention;

FIG. 2 is a flowchart showing operations of the reproducing apparatus shown in FIG. 1;

FIG. 3 is a graph showing a relationship between amount of stored data and threshold, in the reproducing apparatus shown in FIG. 1;

FIG. 4 is a graph showing a relationship between amount of stored data and threshold, in the reproducing apparatus shown in FIG. 1;

FIG. 5 is a block diagram showing a structure of a reproducing apparatus according to a second embodiment of the present invention;

FIG. 6 is a flowchart showing operations of the reproducing apparatus shown in FIG. 5;

FIG. 7 is a graph showing a relationship between amount of stored data and threshold, in the reproducing apparatus shown in FIG. 5; and

FIG. 8 is a graph showing a relationship between amount of stored data and threshold, in the reproducing apparatus shown in FIG. 5.

### DETAILED DESCRIPTION OF THE INVENTION

Embodiments of the present invention will be explained below with reference to the accompanying drawings.

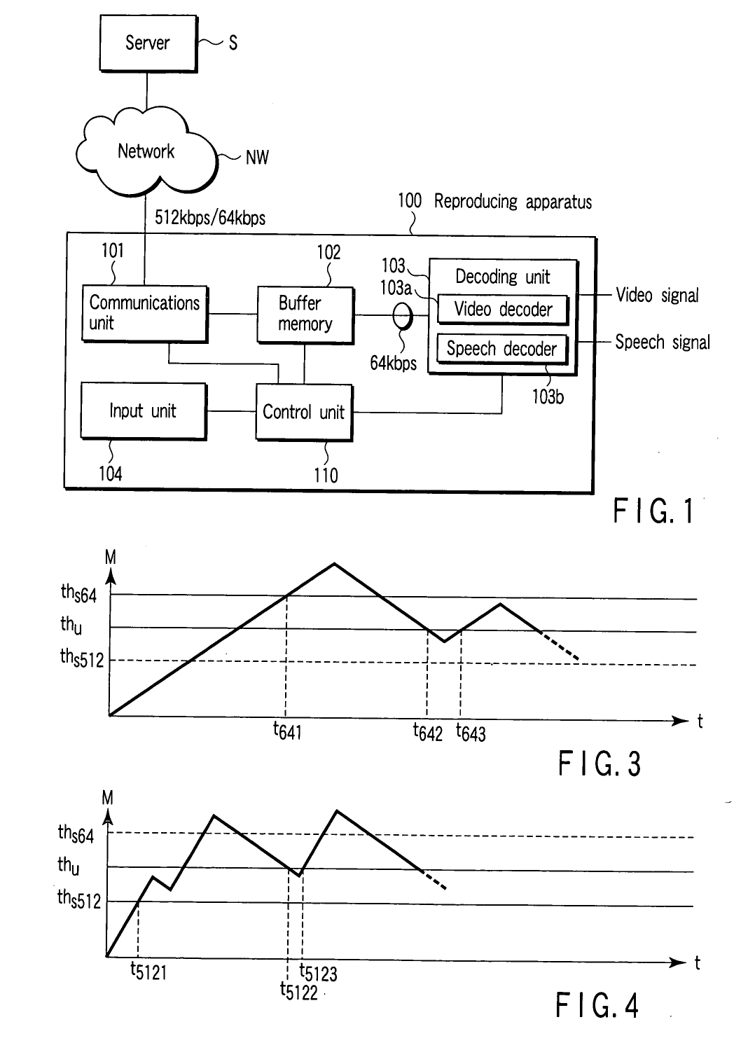

FIG. 1 shows a configuration of a reproducing apparatus 100 according to a first embodiment of the present invention. The reproducing apparatus 100 comprises a communications unit 101, a buffer memory 102, a decoding unit 103, an input unit 104 and a control unit 110.

The communications unit 101 carries out communications with server S via network NW such as Internet, LAN, and the like in accordance with instructions from the control unit 110. Transmission speed thereof is selectively changed to 64 kbps or 512 kbps in accordance with instructions from the control unit 110.

The buffer memory 102 temporarily stores the data downloaded from the server S via the network NW by the communications unit 101. The stored data is read by the control unit 110 and output to the decoding unit 103.

The decoding unit 103 decodes the data read from the buffer memory 102. Video data contained in the data is decoded by a video decoder 103a and output as a video signal. Speech data contained in the data is decoded by a speech decoder 103b and output as a speech signal.

The input unit 104 accepts various requests from the user and notifies the control unit 110 of the requests. The requests are, for example, designation of a remote terminal to be communicated, designation of a transmission speed of the communications unit 101, an instruction to start decoding to be provided by the decoding unit 103, and the like.

The control unit 110 includes a processor and a memory. The memory stores control programs, control data, and the like and the processor controls a plurality of functions of the reproducing apparatus 100 based upon the control programs and control data.

Control functions of the control unit 110 are, for example, a function of detecting the amount of the data stored in the buffer memory 102, a function of selecting the remote terminal, a function of changing the transmission speed of the communications unit 101, a function of controlling the decoding function of the decoding unit 103 in accordance with the attribution information of data received by the communications unit 101, and the like.

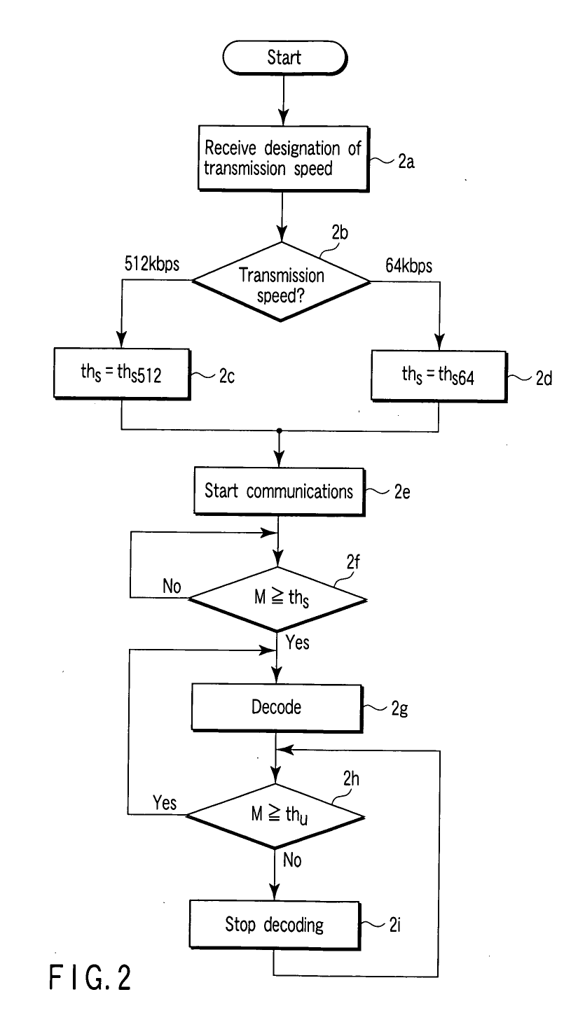

Next, operations of the reproducing apparatus 100 will be described. FIG. 2 is a flowchart of the operations executed by the control unit 110. The control programs and control data corresponding to the flowchart are stored in the memory of the control unit 110 and the control unit 110 operates on the basis of the control programs and the control data.

When the control unit 110 receives a request from the user via the input unit 104, the control unit 110 executes the process corresponding to the request.

First, in step 2a, the control unit 110 receives designation of the transmission speed and/or information indicating a remote terminal from the user via the input unit 104, and the process proceeds to step 2b.

In step 2b, the control unit 110 determines whether the input transmission speed in step 2a is 512 kbps or 64 kbps. If the control unit 110 detects the transmission speed being 512 kbps, the process proceeds to step 2c. On the other hand, if the control unit 110 detects the transmission speed being 64 kbps, the process proceeds to step 2d.

In step 2c, the control unit 110 sets thₛ₅₁₂ as reproduction start threshold thₛ, and the process proceeds to step 2e. In step 2d, the control unit 110 sets thₛ₆₄ as reproduction start threshold thₛ, and the process proceeds to step 2e.

It is noted that thₛ₅₁₂ is smaller than thᵤ and thᵤ is smaller than thₛ₆₄, where thᵤ represents a threshold (hereinafter called BUF threshold) to detect buffer-underflow. Thₛ₅₁₂, thᵤ, and thₛ₆₄ are preset in the control unit 110.

In step 2e, the control unit 110 controls the communications unit 101 to carry out communications with the server S via the network NW at the transmission speed input in step 2a and start downloading the contents data. Then the process proceeds to step 2f.

The downloaded data is stored in the buffer memory 102 by the control unit 110. The contents data is, for example, speech data such as music and voice data, video data which does not include speech data, multimedia data containing speech data and video data, text data, and the like. The text data is decoded by the control unit 110.

In step 2f, the control unit 110 detects amount of data M stored in the buffer memory 102 and determines whether the detected amount of data M is equal to or greater than the reproduction start threshold thₛ. If the detected amount of data M is equal to or greater than the reproduction start threshold thₛ, the process proceeds to step 2g. If the detected amount of data M is smaller than the reproduction start threshold thₛ, the process proceeds to step 2f and continues monitoring the amount of data M.

In step 2g, the control unit 110 reads the data stored in the buffer memory 102, outputs the data to the decoding unit 103, and the process proceeds to step 2h. The data read from the buffer memory 102 is erased in the buffer memory 102. When the data is input to the decoding unit 103, the decoding unit 103 decodes the input data in accordance with the attribution information. For example, if the input data is multimedia data, the decoding unit 103 decodes the video data contained in the data by the video decoder 103a and outputs the video data as an video signal, and decodes the speech data contained in the data by the speech decoder 103b and outputs the speech data as a speech signal.

If the input data is music data alone, the decoding unit 103 decodes the speech data contained in the data by the speech decoder 103b and outputs the speech data as a speech signal.

In step 2h, the control unit 110 detects amount of data M stored in the buffer memory 102 and determines whether the detected amount of data M is equal to or greater than the BUF threshold thᵤ. If the detected amount of data M is equal to or greater than the BUF threshold thᵤ, the process proceeds to step 2g, and the control unit 110 reads the data from the buffer memory 102 and continues decoding. If the detected amount of data M is smaller than the BUF threshold thᵤ, the process proceeds to step 2i.

In a case where the transmission speed is 512 kbps, the detected amount of data M may fall below the BUF threshold thᵤ after the decoding unit 103 starts decoding. Thus, even if the detected amount of data M is smaller than the BUF threshold thᵤ, the control unit 110 temporarily determines that the detected amount of data M is equal to or greater than the BUF threshold thᵤ, until the detected amount of data M exceeds the BUF threshold thᵤ. This temporary determination is set to be valid until the detected amount of data M exceeds the BUF threshold thᵤ for the first time or during a predetermined period, and needs not to be permanent.

In step 2i, control unit 110 stops reading the data stored in the buffer memory 102 and stops decoding of the decoding unit 103, and the process proceeds to step 2h.

If the data input is stopped, the speech decoder 103b outputs a silence signal and the video decoder 103a continues outputting the last video signal that is decoded immediately before the data input is stopped. In a case of the multimedia data, a still image is therefore output by an outputting means (not shown) of a subsequent stage.

Next, variation in the amount of data M stored in the buffer memory 102 under the above-explained control will be described. FIG. 3 shows variation in the amount of data M in a case where the communications unit 101 carries out communications at the transmission speed of 64 kbps.

FIG. 4 shows variation in the amount of data M in a case where the communications unit 101 carries out communications at the transmission speed of 512 kbps. In the examples shown in FIG. 3 and FIG. 4, coding rate of the data to be reproduced is set at 64 kbps, and the decoding unit 103 reads the data from the buffer memory 102 at an average rate of 64 kbps and then decodes the data.

As shown in FIG. 3, in a case where the communications unit 101 carries out communications at 64 kbps, if the amount of data M exceeds thₛ₆₄ (time t₆₄₁) after the start of the communications, the control unit 110 reads the data from the buffer memory 102 and outputs the data to the decoding unit 103. Decoding is thereby started.

After that, if the amount of data M reduces for some reasons such as temporary fading of transmission quality and the amount of data M becomes smaller than thᵤ (time t₆₄₂), the control unit 110 stops reading the data from the buffer memory 102 and decoding is thereby suspended.

After that, if the communications is restarted and the amount of data M in the buffer memory 102 increases and becomes equal to or greater than thᵤ (time t₆₄₃), the control unit 110 reads the data from the buffer memory 102 and outputs the data to the decoding unit 103. Decoding is thereby restarted.

As shown in FIG. 4, in a case where the communications unit 101 carries out communications at 512 kbps, if the amount of data M exceeds thₛ₅₁₂ (time t₅₁₂₁) after the start of the .communications, the control unit 110 reads the data from the buffer memory 102 and outputs the data to the decoding unit 103. Decoding is thereby started.

After that, if the amount of data M reduces for some reasons such as temporary suspension of communications and the amount of data M becomes smaller than thᵤ (time t₅₁₂₂), the control unit 110 stops reading the data from the buffer memory 102 and decoding is thereby suspended.

After that, if the communications is restarted and the amount of data M increases and becomes equal to or greater than thᵤ (time t₅₁₂₃), the control unit 110 reads the data from the buffer memory 102 and inputs the data to the decoding unit 103. Decoding is thereby restarted.

In the reproducing apparatus 100, as described above, the reproduction start threshold thₛ used to determine the start of decoding the received data after the start of the communications, and the BUF threshold thᵤ used to determine the interruption of decoding after the start of decoding the data, are set separately from each other, and the operations of the decoding unit 103 are thereby controlled.

In a case where the communication speed is high, i.e. 512 kbps, the reproduction start threshold thₛ₅₁₂ is set to be smaller than the BUF threshold thᵤ. The time required until the start of the data reproduction can be reduced as compared with a conventional case where the reproduction start threshold thₛ₅₁₂ is equal to the BUF threshold thᵤ.

In a case where the transmission speed is low, i.e. 64 kbps, the reproduction start threshold thₛ₆₄ is set to be greater than the BUF threshold thᵤ. In other words, data reproduction is started after a sufficient amount of data is stored in the buffer memory 102. Thus, the conditions that the amount of data M stored in the buffer memory 102 becomes smaller than the threshold and buffer-underflow thereby occurs simultaneously with the start of the data reproduction, can easily be prevented as compared with the case where the reproduction start threshold thₛ₆₄ is equal to the BUF threshold thᵤ similarly to the prior art.

Therefore, in the reproducing apparatus 100 of the above-described structure, user convenience is enhanced since the time required until the start of the data reproduction can be reduced in a case where the transmission speed is relatively higher than the reproduced data coding rate, and since occurrence of buffer-underflow can be restricted in a case where the transmission speed is approximate to the reproduced data coding rate. More time required until the start of the data reproduction can be reduced as the transmission speed becomes higher than the reproduced data coding rate.

Next, the second embodiment of the present invention will be described.

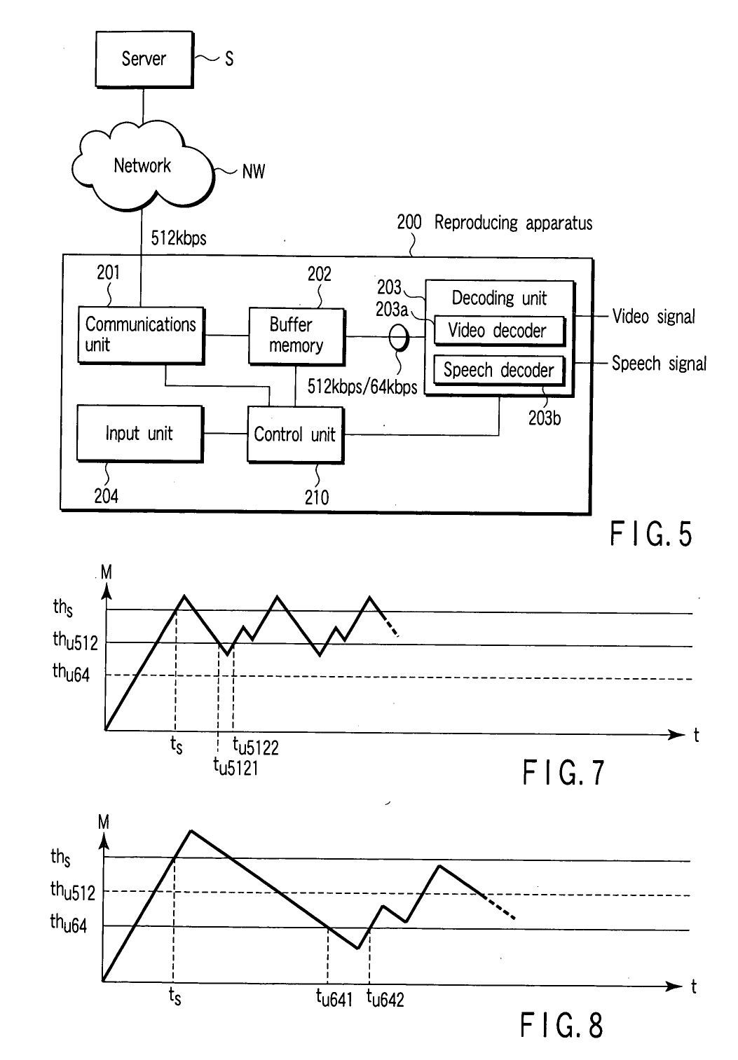

FIG. 5 shows a configuration of reproducing apparatus 200 according to the second embodiment of the present invention. The reproducing apparatus 200 comprises a communications unit 201, a buffer memory 202, a decoding unit 203, an input unit 204 and a control unit 210.

The communications unit 201, the buffer memory 202, the decoding unit 203, the input unit 204 and the control unit 210 are the same as the communications unit 101, the buffer memory 102, the decoding unit 103, the input unit 104 and the control unit 110 of the first embodiment, respectively.

The communications unit 201 carries out communications at 512 kbps via the network NW. There are two kinds of data in the downloaded data from the server S, i.e. low-quality data decoded at 64 kbps by the decoding unit 203 and high-quality data decoded at 512 kbps by the decoding unit 203.

The coding rate used for reproducing by the decoding unit 203 is 512 kbps or 64 kbps corresponding to the quality described above, and the coding rate is selected in accordance with an instruction from the control unit 210.

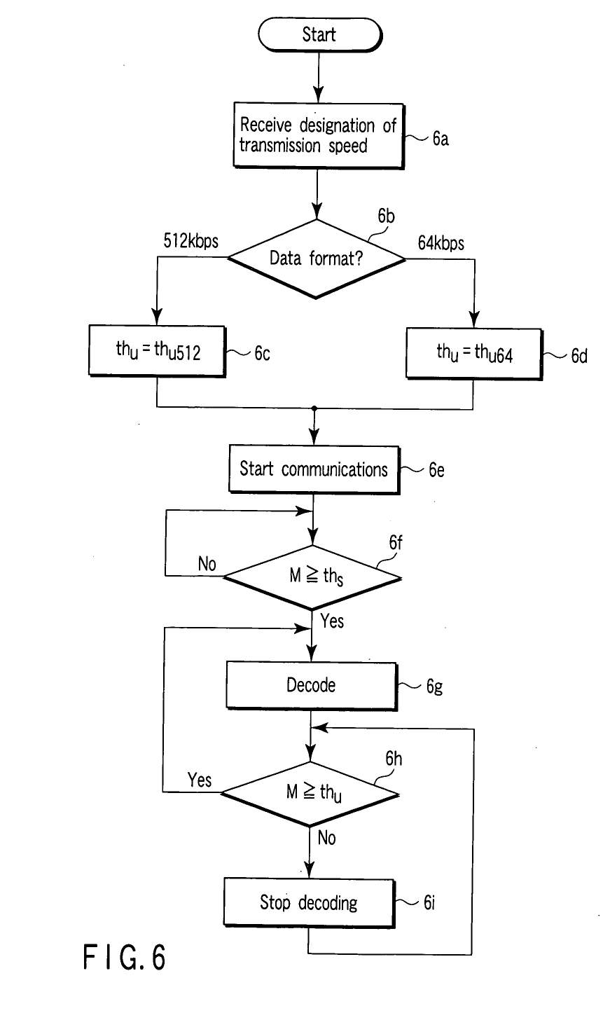

Next, operations of the reproducing apparatus 200 will be described. FIG. 6 is a flowchart showing the operations. The control operations shown in FIG. 6 are executed by the control unit 210. The control programs and control data corresponding to the flowchart are stored in the memory of the control unit 210 and the control unit 210 operates on the basis of the control programs and the control data.

When the control unit 210 receives a request from the user via the input unit 204, the control unit 210 executes the process corresponding to the request.

First, in step 6a, the control unit 210 receives designation of the transmission speed and/or information indicating a remote terminal from the user via the input unit 204, and the process proceeds to step 6b.

In step 6b, the control unit 210 determines whether format of the data designated in step 6a is data to be decoded at 512 kbps or data to be decoded at 64 kbps. If the designated data is data to be decoded at 512 kbps, the process proceeds to step 6c. If the designated data is data to be decoded at 64 kbps, the process proceeds to step 6d.

In step 6c, the control unit 210 sets thᵤ₅₁₂ as a threshold (hereinafter called BUF threshold) to detect buffer-underflow thᵤ, and the process proceeds to step 6e. In step 6d, the control unit 210 sets thᵤ₆₄ as BUF threshold thᵤ, and the process proceeds to step 6e.

It is noted that thᵤ₆₄ is smaller than thᵤ₅₁₂ and thᵤ₅₁₂ is smaller than thₛ, where thₛ represents a threshold to start decoding. thᵤ₆₄, thᵤ₅₁₂, and thₛ are prestored in the control unit 210. Unlike the first embodiment, these thresholds are compared by converting the amounts of data into the reproduction times.

In step 6e, the control unit 210 controls the communications unit 201 to carry out communications with the server S via the network NW at the transmission speed of 512 kbps and start downloading the contents data. Then the control unit 210 shifts to step 6f.

The downloaded data is stored in the buffer memory 202 by the control unit 210.

In step 6f, the control unit 210 detects amount of data M stored in the buffer memory 202 and determines whether the detected amount of data M is equal to or greater than the reproduction start threshold thₛ. If the detected amount of data M is equal to or greater than the reproduction start threshold thₛ, the process proceeds to step 6g. If the detected amount of data M is smaller than the reproduction start threshold thₛ, the process proceeds to step 6f, and the control unit 210 continues monitoring the amount of data M.

In step 6g, the control unit 210 reads the data stored in the buffer memory 202, outputs the data to the decoding unit 203, and shifts to step 6h. The data read from the buffer memory 202 is erased in the buffer memory 202. When the data is input to the decoding unit 203, the decoding unit 203 decodes the input data in accordance with attribution information.

The decoding unit 203 determines whether the input data is the data of the form which should be reproduced at 512 kbps or the data of the form which should be reproduced at 64 kbps, and executes decoding in accordance with the data form.

If the input data is multimedia data, the decoding unit 203 decodes the video data contained in the data by the video decoder 203a and outputs the video data as a video signal, and decodes the speech data contained in the data by the speech decoder 203b and outputs the speech data as a speech signal.

If the input data is music data alone, the decoding unit 203 decodes the speech data contained in the data by the speech decoder 203b and outputs the speech data as a speech signal.

In step 6h, the control unit 210 detects amount of data M stored in the buffer memory 202 and determines whether the detected amount of data M is equal to or greater than the BUF threshold thᵤ. If the detected amount of data M is equal to or greater than the BUF threshold thᵤ, the process proceeds to step 6g, and the control unit 210 reads the data and continues decoding. If the detected amount of data M is smaller than the BUF threshold thᵤ, the process proceeds to step 6i.

In step 6i, control unit 210 stops reading the data stored in the buffer memory 202 and stops decoding of the decoding unit 203, and the process proceeds to step 6h.

When the data input is stopped, the speech decoder 203b outputs a silence signal and the video decoder 203a continues outputting the last video signal that is decoded immediately before the data input is stopped. A still image is therefore output by an outputting means (not shown) of a subsequent stage, in a case of the multimedia data.

Next, fluctuation in the amount of data M stored in the buffer memory 202 under the above-explained control will be described. FIG. 7 shows fluctuation in the amount of data M in a case where the communications unit 201 downloads the data to be decoded at 512 kbps.

FIG. 8 shows fluctuation in the amount of data M in a case where the communications unit 201 downloads the data to be decoded at 64 kbps. In the examples shown in FIG. 7 and FIG. 8, the communications unit 201 executes downloading at 512 kbps.

As shown in FIG. 7, in a case where the communications unit 201 executes downloading at 512 kbps, if the amount of data M exceeds thₛ (time tₛ) after the start of the communications, the control unit 210 reads the data from the buffer memory 202 and outputs the data to the decoding unit 203. Decoding is thereby started.

After that, if the amount of data M reduces for some reasons such as fading of transmission quality and the amount of data M becomes smaller than thᵤ₅₁₂ (time tᵤ₅₁₂₁), the control unit 210 stops reading the data from the buffer memory 202 and decoding is thereby suspended.

After that, if the communications is restarted and the amount of data M increases and becomes equal to or greater than thᵤ₅₁₂ (time tᵤ₅₁₂₂), the control unit 210 reads the data from the buffer memory 202 and outputs the data to the decoding unit 203. Decoding is thereby restarted.

As shown in FIG. 8, in a case where the communications unit 201 downloads the data to be decoded at 64 kbps, if the amount of data M exceeds thₛ (time tₛ) after the start of the communications, the control unit 210 reads the data from the buffer memory 202 and outputs the data to the decoding unit 203. Decoding is thereby started.

After that, if the amount of data M reduces for some reasons such as fading of transmission quality and the amount of data M becomes smaller than thᵤ₆₄ (time tᵤ₆₄₁), the control unit 210 stops reading the data from the buffer memory 202 and decoding is thereby interrupted.

After that, if the communications is restarted and the amount of data M increases and becomes equal to or greater than thᵤ₆₄ (time tᵤ₆₄₂), the control unit 210 reads the data from the buffer memory 202 and outputs the data to the decoding unit 203. Decoding is thereby restarted.

In the reproducing apparatus 200, as described above, the reproduction start threshold thₛ used to determine the start of decoding the received data after the start of the communications, and the BUF threshold thᵤ used to determine the suspension of decoding after the start of decoding the data, are set individually from each other to control the operations of the decoding unit 203.

In addition, the BUF threshold thᵤ is set to be smaller than the reproduction start threshold thₛ, and the BUF threshold thᵤ₅₁₂ in a case where the data to be decoded at 512 kbps is downloaded is set to be greater than the BUF threshold thᵤ₆₄ in a case where the data to be decoded at 64 kbps is downloaded.

Therefore, in the reproducing apparatus 200 of the above-described configuration, data reproduction is started after a sufficient amount of data is stored in the buffer memory 202. Thus, the conditions that the amount of data M stored in the buffer memory 202 becomes smaller than the threshold and buffer-underflow thereby occurs simultaneously with the start of the data reproduction, can easily be prevented as compared with the case where the reproduction start threshold thₛ is equal to the BUF threshold thᵤ similarly to the prior art.

In addition, the BUF threshold thᵤ₆₄ of the data to be decoded at 64 kbps at which the data is hardly exhausted in the buffer memory 202 is set to be smaller than the BUF threshold thᵤ₅₁₂ of the data to be decoded at 512 kbps. Thus, the occurrence of buffer-underflow can be determined more properly than a case of determining the occurrence of buffer-underflow with common BUF threshold thᵤ.

In a case as shown in the prior art where the occurrence of buffer-underflow is determined while the threshold to start the reproduction and the threshold to detect the occurrence of the buffer-underflow are set as common BUF threshold thᵤ, for example, inconvenience that the occurrence of buffer-underflow is unnecessarily detected and thereby decoding is stopped may occur at the time of decoding the data to be decoded at a low speed or inconvenience that determination of the occurrence of buffer-underflow is delayed may occur at the time of decoding the data to be decoded at a high speed.

In the reproducing apparatus 200 of the above-described configuration, however, since the occurrence of buffer-underflow is determined with the BUF threshold thᵤ responding to the speed of decoding the data, the occurrence of the inconvenience can be prevented and user convenience is enhanced.

The present invention is not limited to the embodiments described above.

For example, in the above-described embodiments, the data is downloaded from the server S via the network NW. However, means for reading data from a storage such as CD, DVD, hard disk, flash memory or the like can be provided, instead of the communications unit 101, 201, to read the data from the storage and store the data in the buffer memory 102, 202.

In addition, the above-explained means and the communications unit 101, 201 can also be simultaneously provided and selectively employed to store the data in the communications unit 101, 201. In this case, the reproducing apparatus 200 of the second embodiment is particularly preferable since the above-explained means and the communications unit 101, 201 are different in data input speed.

What is claimed is:

1. A reproducing apparatus comprising:
receiving means for receiving encoded data;
a buffer storage configured to store the received encoded data;
decoding means for decoding the encoded data stored in the buffer storage; and
control means for reading the encoded data stored in the buffer storage and outputting the encoded data to the decoding means if an amount of data stored in the buffer storage becomes equal to or greater than a first threshold, and for suspending the decoding means if the amount of the data stored in the buffer storage becomes smaller than a second threshold, wherein the first threshold differs from the second threshold.

2. The reproducing apparatus according to claim 1, wherein the first threshold is greater than the second threshold.

3. The reproducing apparatus according to claim 1, wherein the second threshold is greater than the first threshold.

4. The reproducing apparatus according to claim 1, wherein the receiving means receives the encoded data via the Internet.

5. The reproducing apparatus according to claim 1, wherein the encoded data is encoded multimedia data containing speech data and video data.

6. The reproducing apparatus according to claim 1, further including erasing means for erasing the encoded data stored in the buffer storage after the control means has read the encoded data.

7. A reproducing apparatus comprising:
receiving means for receiving encoded data which is encoded corresponding to one of a first transmission speed and a second transmission speed, wherein the second transmission speed is higher than the first transmission speed;
a buffer storage configured to store the received encoded data;
decoding means for decoding the encoded data stored in the buffer storage;
first control means for reading the encoded data stored in the buffer storage and outputting the encoded data to the decoding means if an amount of the encoded data stored in the buffer storage becomes equal to or greater than a first threshold after starting the encoded data reception, which corresponds to the first transmission speed, and for suspending reading the encoded data stored in the buffer storage if the amount of the encoded data stored in the buffer storage becomes smaller than a second threshold that is smaller than the first threshold; and
second control means for reading the encoded data stored in the buffer storage and outputting the encoded data to the decoding means if the amount of the data stored in the buffer storage means becomes equal to or greater than a third threshold that is smaller than the second threshold after starting the encoded data reception, which corresponds to the second transmission speed, and for suspending reading the encoded data stored in the buffer storage if the amount of the data stored in the buffer storage becomes smaller than the second threshold after outputting the encoded data to the decoding means.

8. The reproducing apparatus according to claim 7, wherein the receiving means receives the encoded data via the Internet.

9. The reproducing apparatus according to claim 7, wherein the encoded data is encoded multimedia data containing speech data and video data.

10. A reproducing apparatus comprising:
receiving means for receiving encoded data;
a buffer storage configured to store the received encoded data;
decoding means for decoding the encoded data stored in the buffer storage;
first control means for reading the encoded data stored in the buffer storage and outputting the encoded data to the decoding means at a first transmission speed if an amount of the encoded data stored in the buffer storage becomes equal to or greater than a first threshold after starting the encoded data reception, and for suspending reading the encoded data stored in the buffer storage if the amount of the data stored in the buffer storage becomes smaller than a second threshold that is smaller than the first threshold; and
second control means for reading the encoded data stored in the buffer storage and outputting the encoded data to the decoding means at a second transmission speed slower than the first transmission speed if the amount of the data stored in the buffer storage is equal to or greater than the first threshold after starting the encoded data reception, and for suspending reading the encoded data stored in the buffer storage if the amount of the encoded data stored in the buffer storage is smaller than a third threshold that is smaller than the second threshold.

11. The reproducing apparatus according to claim 10, wherein the receiving means receives the encoded data via the Internet.

12. The reproducing apparatus according to claim 10, wherein the encoded data is encoded multimedia data containing speech data and video data.
